(19) United States
(12) Patent Application Publication
(10) Pub. No.: US 2026/0161411 A1
(43) Pub. Date: Jun. 11, 2026

(54) SHORT FORWARD BRANCH PREDICTOR

(71) Applicant: Intel Corporation, Santa Clara, CA (US)

(72) Inventors: Christopher Celio, Hillsboro, OR (US); Jared Warner Stark, IV, Portland, OR (US); Ariel Sabba, Lavon (IL); Dinesh Jain, Austin, TX (US); Ammon J. Christiansen, Warren, OR (US); Krishan Malik, Portland, OR (US); Andre Seznec, Acigne (FR); Eliyah Kilada, Portland, OR (US)

(73) Assignee: Intel Corporation, Santa Clara, CA (US)

(21) Appl. No.: 18/972,500

(22) Filed: Dec. 6, 2024

(51) Int. Cl. G06F 9/38; G06F 9/30

(52) U.S. Cl. CPC G06F 9/3806; G06F 9/30058; G06F 9/3016

(57) ABSTRACT

Methods and apparatus relating to a short forward branch predictor are described. In an embodiment, a processor includes a Short Forward Branch (SFB) predictor to process one or more short forward branches. The processor also includes main branch predictor logic circuitry to process one or more long forward branches. The one or more short forward branches jump forward a shorter distance than the long forward branches. Other embodiments are also disclosed and claimed.

### FIELD OF THE INVENTION

The present disclosure generally relates to the field of processors. More particularly, some embodiments relate to Short Forward Branch (SFB) predictor.

### BACKGROUND OF THE INVENTION

To improve performance, some processors utilize speculative processing (also sometimes referred to as Out-Of-Order (OOO) processing), which attempts to predict the future course of an executing program to speed its execution, for example, by employing parallelism. The predictions may or may not end up being correct. When they are correct, a program may execute in less time than when non-speculative processing is employed. When a prediction is incorrect, however, the processor has to recover its state to a point prior to the misprediction which can create inefficiencies.

Moreover, in modern superscalar OOO processors, performance can be significantly affected by branch mispredictions, which result in a large amount of work being flushed from a processor's pipeline and in instructions from the correct path being delayed from entering the processor pipeline. As instruction windows of processors expand, the penalties from control flow mis-speculation continue to increase.

Hence, there is a general need to improve prediction latency and reduce mispredictions.

### BRIEF DESCRIPTION OF DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates sample prediction blocks handled by branch predictors, according to an embodiment.

FIG. 2 illustrates a hybrid prediction unit, according to an embodiment.

FIG. 3 illustrates an example computing system.

FIG. 4 illustrates a block diagram of an example processor and/or System on a Chip (SoC) that may have one or more cores and an integrated memory controller.

FIG. 5(A) is a block diagram illustrating both an example in-order pipeline and an example register renaming, out-of-order issue/execution pipeline according to examples.

FIG. 5(B) is a block diagram illustrating both an example in-order architecture core and an example register renaming, out-of-order issue/execution architecture core to be included in a processor according to examples.

FIG. 6 illustrates examples of execution unit(s) circuitry.

### DETAILED DESCRIPTION OF THE INVENTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, there is a general need to improve prediction latency and reduce mispredictions. Moreover, modern high-performance processors are bottlenecked by the number of taken branches the front-end of a processor can predict every cycle. Taken branches change the control flow of the instruction stream, jumping to a new point in the program, which limits the average size of contiguous instruction fetch bundles that can then be sent to the processor back-end for execution. By increasing the number of taken branches the Branch Prediction Unit (BPU) can predict in a cycle, this critical bottleneck in the front-end can be removed and processors can utilize a wider back-end machine width and increase performance. However, it is extremely difficult to predict more than one taken branch per cycle since the prediction for the second taken branch is dependent on knowing the outcome of the first taken branch.

To this end, some embodiments provide a Short Forward Branch (SFB) predictor. As discussed herein, a “short forward branch” generally refers to a branch that jumps forward a short distance, e.g., on the order of about 128 bytes (and thus stays within a normal fetch bundle). In an embodiment, an SFB predictor is used to predict only short, forward branches. The SFB may be composed of one or more prediction tables including a Branch Target Buffer (BTB) to store branch decode information and a Conditional Branch Predictor (CBP) to predict whether a branch should be taken or not taken.

In at least one embodiment, the SFB predictor takes advantage of a common pattern of branch behavior to provide a limited solution to increase taken-branch bandwidth. In one embodiment, the SFB predictor operates later in the processor pipeline (i.e., after instructions have been fetched from the fetch unit) and “masks out” any instructions within the fetch bundle that are jumped over by the taken short forward branch. Furthermore, although an SFB predictor may add additional capacity to the overall BPU, it may generally not have a positive impact on misprediction rates as the short forward branches can no longer participate in the main predictor's path history.

In some embodiments, the short forward branch predictor allows the BPU to decouple the branch prediction problem to capture better throughput and potentially accuracy. In an embodiment, the main BPU predictor is kept and used as a “coarse-grain” predictor that will take care of the next prediction block and then use a new SFB predictor to handle the internal taken branch predictions within a prediction block. While the main predictor has a latency constraint, the short forward branch predictor is not part of the main prediction loop and can provide the prediction further down the processor pipeline. This allows an implementation to layer on adding more taken-branch prediction bandwidth. Also, keeping the prediction outside of the loop may be an essential and strategic aspect of enabling extra capacity and thus to gain accuracy.

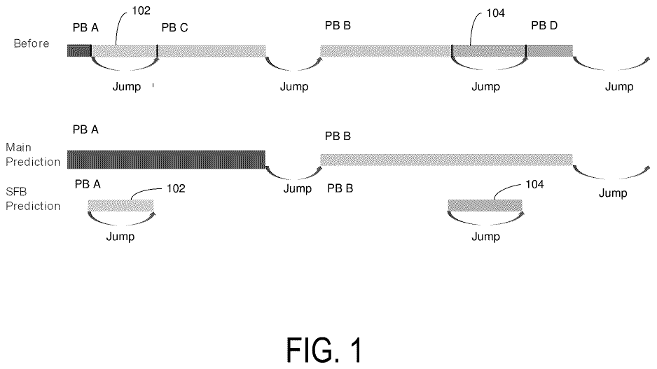

FIG. 1 illustrates sample prediction blocks handled by a main BPU and an SFB predictor, according to an embodiment. The sample prediction blocks (labeled as “PB” in FIG. 1) cover an entry address into the block and terminate with a taken branch that jumps out of the block and into the entry of a new block. The main predictor predicts the “coarse-grain” control flow of new prediction blocks while the SFB predictor handles “fine-grain” control flow that stays within the prediction/fetch block, allowing for potentially doubling of the taken-branch bandwidth.

Referring to FIG. 1, the top portion shows how a main BPU would handle prediction blocks, while the bottom portion shows how different prediction blocks may be divided between a main predictor and an SFB predictor. With a main predictor only (top portion labeled as “before”), PB A jumps to PB C, PB C jumps to PB B which jumps to PB D, and so on. Hence, the top portion shows four taken branches where a normal processor would have to take four cycles to process.

Considering the bottom portion of FIG. 1, a main predictor handles PB A jump to PB B, while an SFB predictor handles the short forward branches 102 and 104. Hence, an embodiment allows for the removal of SFB branches from the main BPU path and instead handles the SFB branches with an SFB predictor in parallel with the main BPU operations. This allows for masking of the delays associated with handling SFB branches and potentially double branch prediction throughput. For example, this division allows for the processor to handle the four taken branches in two cycles instead of the approach before.

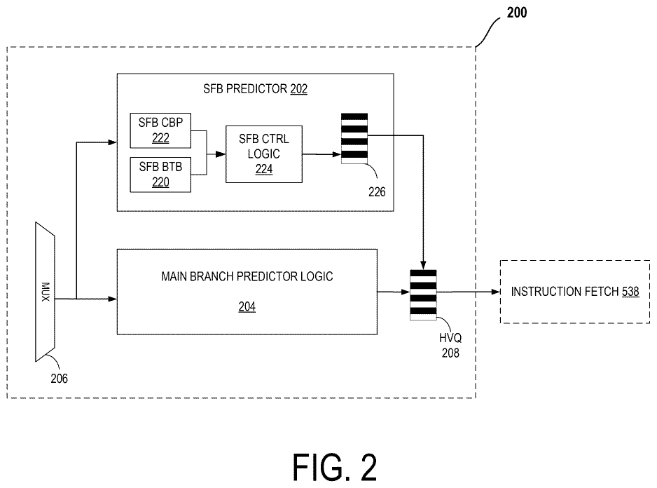

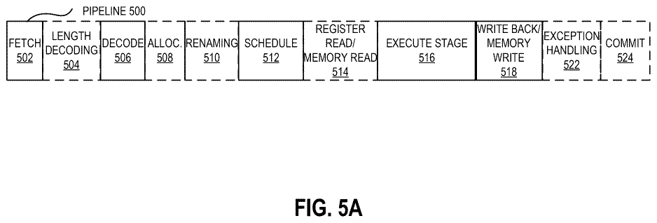

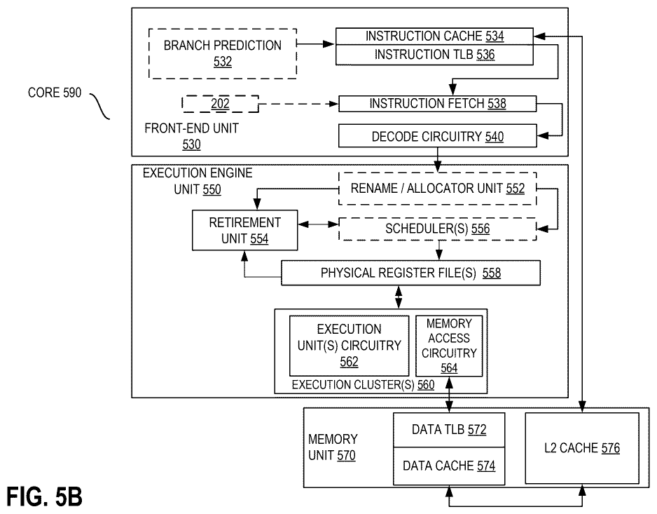

FIG. 2 illustrates a hybrid prediction unit 200, according to an embodiment. Prediction unit 200 includes an SFB predictor 202 and a main branch predictor logic 204 (which may also be referred to herein as a “main BPU” or more generally a “BPU”). In an embodiment, the main branch predictor logic 204 may include one or more components of the front-end unit 530 of FIG. 5B, including, for example, branch prediction circuitry 532, instruction cache circuitry 534, and instruction translation lookaside buffer (TLB) 536. Both SFB predictor 202 and main branch predictor logic 204 may receive their inputs an input multiplexer 206 and store their outputs in a Hit Vector Queue (HVQ) 208. In turn, HVQ 208 may drain its entries to an instruction fetch circuitry 538 of FIG. 5B.

As shown in FIG. 2, the SFB predictor 202 includes:
(1) An SFB BTB 220—this is a Branch Target Buffer (BTB) which stores the branch decode information, indicating whether there is a branch, what type of branch, and where does the taken branch jump to. The BTB may sometimes be referred to as a Target Array (TA).
(2) An SFB CBP 222—this Conditional Branch Predictor (CBP) predicts the direction of any conditional branch.
(3) SFB CTRL LOGIC 224—this SFB control logic synthesis a prediction from the outputs of the SFB BTB 220 and SFB CBP 222 to determine whether there is a predicted taken SFB, and if so, which branch is it.
(4) SFB Queue 226—this queue stores the outputs of the SFB CTRL Logic 224 and drains into the HVQ 208.

In operation, SFB predictor 202 may start processing SFBs at the same time the main branch predictor logic 204 starts processing branches. Optionally, the SFB predictor 202 may start processing SFBs one or more cycles after the main branch predictor logic 204 starts processing branches. Moreover, the SFB prediction may be accessed at the end of the Branch Prediction Unit pipeline using the most recent prediction information. It can be indexed with the main prediction path history as well as a short-forward-only path history. The outputs of the SFB prediction then intercept instruction fetch requests in the Instruction Fetch Unit (such shown in FIG. 2) to mask out any instructions hidden by a taken short forward branch before the instructions are sent to the back-end of the processor (e.g., execution engine unit 550 of FIG. 5B).

Moreover, in some embodiments, reading out the SFB prediction is different from acting/operating on that prediction. The timing may be summarized as follows in chronological order:
(1) Begin predicting branches (Any predicted-taken branches quickly change the next lookup address. This is the “tight branch prediction loop”).
(2) Look up the SFB predictor.
(3) Cache the results of the SFB predictor in a queue somewhere (such as queues 226 and/or 208).
(4) Read out instructions from the Fetch Unit.
(5) Mask out any instructions that are jumped over, as predicted by the SFB predictor.

The timing of (2) can happen in parallel with (1), or it can happen (e.g., slightly) later. The timing of (3) and (4) are not as restrictive, and could be swapped, as they do not depend serially on each other. And while (3) and (4) are not dependent on one another, the SFB predictor's results cannot be acted upon (5) until the instructions are fetched (4). One important aspect is that getting the results out of the SFB predictor and synthesizing a prediction out of those results is not timing critical, and does not participate in the main branch predictor's critical lookup loop.

Additionally, FIG. 2 shows the SFB predictor's results being placed into the HVQ 208. This allows for consolidation of the general branch prediction and instruction cache lookup tag hit information together with the SFB predictor's results. But embodiments are not limited to this implementation. For example, the results of the SFB predictor may be direct directly to the instruction fetch circuitry 538, so long as there is some sort of system (tags, tokens, etc.) and buffering to match a corresponding instruction fetch with its proper SFB prediction.

Additionally, some embodiments may be applied in computing systems that include one or more processors (e.g., where the one or more processors may include one or more processor cores), such as those discussed with reference to FIG. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

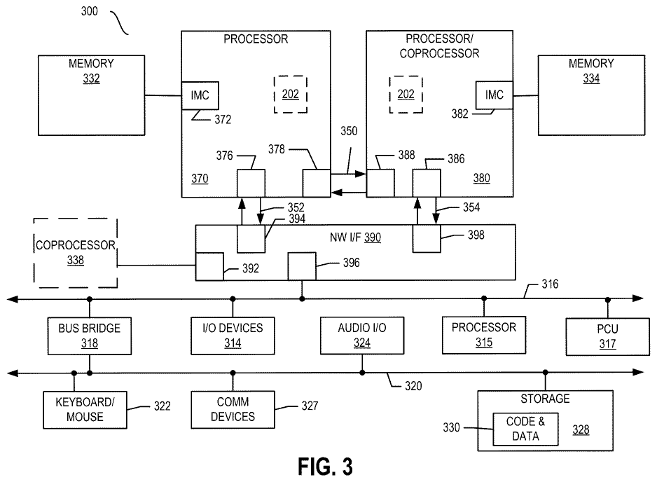

FIG. 3 illustrates an example computing system. Multiprocessor system 300 is an interfaced system and includes a plurality of processors or cores including a first processor 370 and a second processor 380 coupled via an interface 350 such as a point-to-point (P-P) interconnect, a fabric, and/or bus. In some examples, the first processor 370 and the second processor 380 are homogeneous. In some examples, first processor 370 and the second processor 380 are heterogenous. Though the example system 300 is shown to have two processors, the system may have three or more processors, or may be a single processor system. In some examples, the computing system is a system on a chip (SoC).

Processors 370 and 380 are shown including integrated memory controller (IMC) circuitry 372 and 382, respectively. Processor 370 also includes interface circuits 376 and 378; similarly, second processor 380 includes interface circuits 386 and 388. Processors 370, 380 may exchange information via the interface 350 using interface circuits 378, 388. IMCs 372 and 382 couple the processors 370, 380 to respective memories, namely a memory 332 and a memory 334, which may be portions of main memory locally attached to the respective processors.

Processors 370, 380 may each exchange information with a network interface (NW I/F) 390 via individual interfaces 352, 354 using interface circuits 376, 394, 386, 398. The network interface 390 (e.g., one or more of an interconnect, bus, and/or fabric, and in some examples is a chipset) may optionally exchange information with a coprocessor 338 via an interface circuit 392. In some examples, the coprocessor 338 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 370, 380 or outside of both processors, yet connected with the processors via an interface such as P-P interconnect, such that either or both processors'local cache information may be stored in the shared cache if a processor is placed into a low power mode.

Network interface 390 may be coupled to a first interface 316 via interface circuit 396. In some examples, first interface 316 may be an interface such as a Peripheral Component Interconnect (PCI) interconnect, a PCI Express interconnect or another I/O interconnect. In some examples, first interface 316 is coupled to a power control unit (PCU) 317, which may include circuitry, software, and/or firmware to perform power management operations with regard to the processors 370, 380 and/or co-processor 338. PCU 317 provides control information to a voltage regulator (not shown) to cause the voltage regulator to generate the appropriate regulated voltage. PCU 317 also provides control information to control the operating voltage generated. In various examples, PCU 317 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 317 is illustrated as being present as logic separate from the processor 370 and/or processor 380. In other cases, PCU 317 may execute on a given one or more of cores (not shown) of processor 370 or 380. In some cases, PCU 317 may be implemented as a microcontroller (dedicated or general-purpose) or other control logic configured to execute its own dedicated power management code, sometimes referred to as P-code. In yet other examples, power management operations to be performed by PCU 317 may be implemented externally to a processor, such as by way of a separate power management integrated circuit (PMIC) or another component external to the processor. In yet other examples, power management operations to be performed by PCU 317 may be implemented within BIOS or other system software.

Various I/O devices 314 may be coupled to first interface 316, along with a bus bridge 318 which couples first interface 316 to a second interface 320. In some examples, one or more additional processor(s) 315, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 316. In some examples, second interface 320 may be a low pin count (LPC) interface. Various devices may be coupled to second interface 320 including, for example, a keyboard and/or mouse 322, communication devices 327 and storage circuitry 328. Storage circuitry 328 may be one or more non-transitory machine-readable storage media as described below, such as a disk drive or other mass storage device which may include instructions/code and data 330 and may implement the storage ′ISAB03 in some examples. Further, an audio I/O 324 may be coupled to second interface 320. Note that other architectures than the point-to-point architecture described above are possible. For example, instead of the point-to-point architecture, a system such as multiprocessor system 300 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

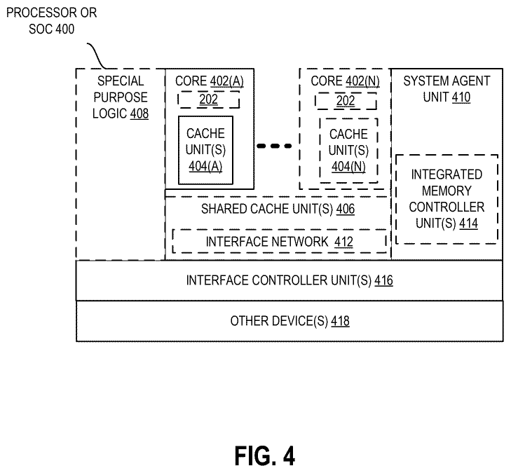

FIG. 4 illustrates a block diagram of an example processor and/or SoC 400 that may have one or more cores and an integrated memory controller. The solid lined boxes illustrate a processor 400 with a single core 402(A), system agent unit circuitry 410, and a set of one or more interface controller unit(s) circuitry 416, while the optional addition of the dashed lined boxes illustrates an alternative processor 400 with multiple cores 402(A)-(N), a set of one or more integrated memory controller unit(s) circuitry 414 in the system agent unit circuitry 410, and special purpose logic 408, as well as a set of one or more interface controller units circuitry 416. Note that the processor 400 may be one of the processors 370 or 380, or co-processor 338 or 315 of FIG. 3.

Thus, different implementations of the processor 400 may include: 1) a CPU with the special purpose logic 408 being integrated graphics and/or scientific (throughput) logic (which may include one or more cores, not shown), and the cores 402(A)-(N) being one or more general purpose cores (e.g., general purpose in-order cores, general purpose out-of-order cores, or a combination of the two); 2) a coprocessor with the cores 402(A)-(N) being a large number of special purpose cores intended primarily for graphics and/or scientific (throughput); and 3) a coprocessor with the cores 402(A)-(N) being a large number of general purpose in-order cores. Thus, the processor 400 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 400 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 404(A)-(N) within the cores 402(A)-(N), a set of one or more shared cache unit(s) circuitry 406, and external memory (not shown) coupled to the set of integrated memory controller unit(s) circuitry 414. The set of one or more shared cache unit(s) circuitry 406 may include one or more mid-level caches, such as level 2(L 2 ), level 3(L 3 ), level 4(L 4 ), or other levels of cache, such as a last level cache (LLC), and/or combinations thereof. While in some examples interface network circuitry 412 (e.g., a ring interconnect) interfaces the special purpose logic 408 (e.g., integrated graphics logic), the set of shared cache unit(s) circuitry 406, and the system agent unit circuitry 410, alternative examples use any number of well-known techniques for interfacing such units. In some examples, coherency is maintained between one or more of the shared cache unit(s) circuitry 406 and cores 402(A)-(N). In some examples, interface controller units circuitry 416 couple the cores 402 to one or more other devices 418 such as one or more I/O devices, storage, one or more communication devices (e.g., wireless networking, wired networking, etc.), etc.

In some examples, one or more of the cores 402(A)-(N) are capable of multi-threading. The system agent unit circuitry 410 includes those components coordinating and operating cores 402(A)-(N). The system agent unit circuitry 410 may include, for example, power control unit (PCU) circuitry and/or display unit circuitry (not shown). The PCU may be or may include logic and components needed for regulating the power state of the cores 402(A)-(N) and/or the special purpose logic 408 (e.g., integrated graphics logic). The display unit circuitry is for driving one or more externally connected displays.

The cores 402(A)-(N) may be homogenous in terms of instruction set architecture (ISA). Alternatively, the cores 402(A)-(N) may be heterogeneous in terms of ISA; that is, a subset of the cores 402(A)-(N) may be capable of executing an ISA, while other cores may be capable of executing only a subset of that ISA or another ISA.

### Example Core Architectures-in-Order and Out-of-Order Core Block Diagram

FIG. 5(A) is a block diagram illustrating both an example in-order pipeline and an example register renaming, out-of-order issue/execution pipeline according to examples. FIG. 5(B) is a block diagram illustrating both an example in-order architecture core and an example register renaming, out-of-order issue/execution architecture core to be included in a processor according to examples. The solid lined boxes in FIG. 5(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 5(A), a processor pipeline 500 includes a fetch stage 502, an optional length decoding stage 504, a decode stage 506, an optional allocation (Alloc) stage 508, an optional renaming stage 510, a schedule (also known as a dispatch or issue) stage 512, an optional register read/memory read stage 514, an execute stage 516, a write back/memory write stage 518, an optional exception handling stage 522, and an optional commit stage 524. One or more operations can be performed in each of these processor pipeline stages. For example, during the fetch stage 502, one or more instructions are fetched from instruction memory, and during the decode stage 506, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 506 and the register read/memory read stage 514 may be combined into one pipeline stage. In one example, during the execute stage 516, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 5(B) may implement the pipeline 500 as follows: 1) the instruction fetch circuitry 538 performs the fetch and length decoding stages 502 and 504; 2) the decode circuitry 540 performs the decode stage 506; 3) the rename/allocator unit circuitry 552 performs the allocation stage 508 and renaming stage 510; 4) the scheduler(s) circuitry 556 performs the schedule stage 512; 5) the physical register file(s) circuitry 558 and the memory unit circuitry 570 perform the register read/memory read stage 514; the execution cluster(s) 560 perform the execute stage 516; 6) the memory unit circuitry 570 and the physical register file(s) circuitry 558 perform the write back/memory write stage 518; 7) various circuitry may be involved in the exception handling stage 522; and 8) the retirement unit circuitry 554 and the physical register file(s) circuitry 558 perform the commit stage 524.

FIG. 5(B) shows a processor core 590 including front-end unit circuitry 530 coupled to execution engine unit circuitry 550, and both are coupled to memory unit circuitry 570. The core 590 may be a reduced instruction set architecture computing (RISC) core, a complex instruction set architecture computing (CISC) core, a very long instruction word (VLIW) core, or a hybrid or alternative core type. As yet another option, the core 590 may be a special-purpose core, such as, for example, a network or communication core, compression engine, coprocessor core, general purpose computing graphics processing unit (GPGPU) core, graphics core, or the like.

The front-end unit circuitry 530 may include branch prediction circuitry 532 coupled to instruction cache circuitry 534, which is coupled to an instruction translation lookaside buffer (TLB) 536, which is coupled to instruction fetch circuitry 538, which is coupled to decode circuitry 540. In one example, the instruction cache circuitry 534 is included in the memory unit circuitry 570 rather than the front-end circuitry 530. The decode circuitry 540 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 540 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 540 may be implemented using various different mechanisms. Examples of suitable mechanisms include, but are not limited to, look-up tables, hardware implementations, programmable logic arrays (PLAs), microcode read only memories (ROMs), etc. In one example, the core 590 includes a microcode ROM (not shown) or other medium that stores microcode for certain macroinstructions (e.g., in decode circuitry 540 or otherwise within the front-end circuitry 530). In one example, the decode circuitry 540 includes a micro-operation (micro-op) or operation cache (not shown) to hold/cache decoded operations, micro-tags, or micro-operations generated during the decode or other stages of the processor pipeline 500. The decode circuitry 540 may be coupled to rename/allocator unit circuitry 552 in the execution engine circuitry 550.

The execution engine circuitry 550 includes the rename/allocator unit circuitry 552 coupled to retirement unit circuitry 554 and a set of one or more scheduler(s) circuitry 556. The scheduler(s) circuitry 556 represents any number of different schedulers, including reservations stations, central instruction window, etc. In some examples, the scheduler(s) circuitry 556 can include arithmetic logic unit (ALU) scheduler/scheduling circuitry, ALU queues, address generation unit (AGU) scheduler/scheduling circuitry, AGU queues, etc. The scheduler(s) circuitry 556 is coupled to the physical register file(s) circuitry 558. Each of the physical register file(s) circuitry 558 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 558 includes vector registers unit circuitry, writemask registers unit circuitry, and scalar register unit circuitry. These register units may provide architectural vector registers, vector mask registers, general-purpose registers, etc. The physical register file(s) circuitry 558 is coupled to the retirement unit circuitry 554 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 554 and the physical register file(s) circuitry 558 are coupled to the execution cluster(s) 560. The execution cluster(s) 560 includes a set of one or more execution unit(s) circuitry 562 and a set of one or more memory access circuitry 564. The execution unit(s) circuitry 562 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 556, physical register file(s) circuitry 558, and execution cluster(s) 560 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster - and in the case of a separate memory access pipeline, certain examples are implemented in which only the execution cluster of this pipeline has the memory access unit(s) circuitry 564). It should also be understood that where separate pipelines are used, one or more of these pipelines may be out-of-order issue/execution and the rest in-order.

In some examples, the execution engine unit circuitry 550 may perform load store unit (LSU) address/data pipelining to an Advanced Microcontroller Bus (AMB) interface (not shown), and address phase and writeback, data phase load, store, and branches.

The set of memory access circuitry 564 is coupled to the memory unit circuitry 570, which includes data TLB circuitry 572 coupled to data cache circuitry 574 coupled to level 2(L 2 ) cache circuitry 576. In one example, the memory access circuitry 564 may include load unit circuitry, store address unit circuitry, and store data unit circuitry, each of which is coupled to the data TLB circuitry 572 in the memory unit circuitry 570. The instruction cache circuitry 534 is further coupled to the level 2 (L2) cache circuitry 576 in the memory unit circuitry 570. In one example, the instruction cache 534 and the data cache 574 are combined into a single instruction and data cache (not shown) in L2 cache circuitry 576, level 3(L 3 ) cache circuitry (not shown), and/or main memory. The L2 cache circuitry 576 is coupled to one or more other levels of cache and eventually to a main memory.

The core 590 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 590 includes logic to support a packed data instruction set architecture extension (e.g., AVX1, AVX2), thereby allowing the operations used by many multimedia applications to be performed using packed data.

### Example Execution Unit(S) Circuitry

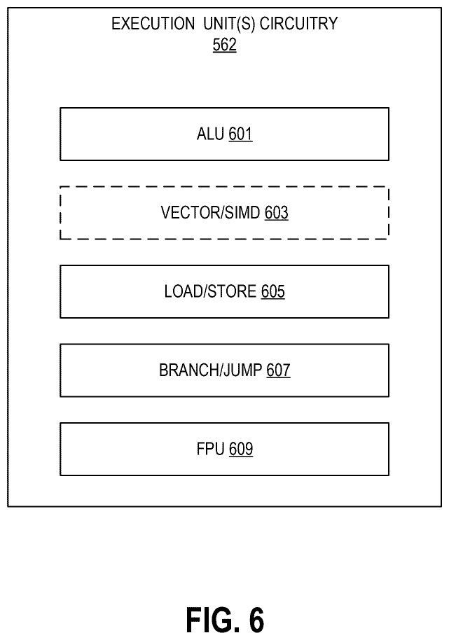

FIG. 6 illustrates examples of execution unit(s) circuitry, such as execution unit(s) circuitry 562 of FIG. 5(B). As illustrated, execution unit(s) circuity 562 may include one or more ALU circuits 601, optional vector/single instruction multiple data (SIMD) circuits 603, load/store circuits 605, branch/jump circuits 607, and/or Floating-point unit (FPU) circuits 609. ALU circuits 601 perform integer arithmetic and/or Boolean operations. Vector/SIMD circuits 603 perform vector/SIMD operations on packed data (such as SIMD/vector registers). Load/store circuits 605 execute load and store instructions to load data from memory into registers or store from registers to memory. Load/store circuits 605 may also generate addresses. Branch/jump circuits 607 cause a branch or jump to a memory address depending on the instruction. FPU circuits 609 perform floating-point arithmetic. The width of the execution unit(s) circuitry 562 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

In this description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes a processor comprising: a Short Forward Branch (SFB) predictor to process one or more short forward branches; and main branch predictor logic circuitry to process one or more long forward branches, wherein the one or more short forward branches jump forward a shorter distance than the long forward branches. Example 2 includes the processor of example 1, wherein the SFB predictor and the main branch predictor logic circuity are to process branches in parallel. Example 3 includes the processor of example 1, wherein each of the one or more short forward branches include a branch that jumps forward a short distance on the order of 128 bytes. Example 4 includes the processor of example 1, wherein the SFB predictor includes a Branch Target Buffer (BTB) to store branch decode information.

Example 5 includes the processor of example 1, wherein the SFB predictor includes a Conditional Branch Predictor (CBP) to predict whether a branch should be taken or not taken. Example 6 includes the processor of example 1, wherein the SFB predictor includes a Branch Target Buffer (BTB) to store branch decode information, a Conditional Branch Predictor (CBP) to predict whether a branch should be taken or not taken, and an SFB controller logic to synthesis a prediction from outputs of the SFB BTB and SFB CBP. Example 7 includes the processor of example 1, further comprising a hit vector queue to store one or more predictions by the SFB predictor and the main branch predictor logic circuitry.

Example 8 includes the processor of example 7, wherein an instruction fetch circuitry is coupled to the hit vector queue to read the one or more stored predictions. Example 9 includes the processor of example 1, wherein a System on Chip (SoC) comprises the SFB predictor and the main branch predictor logic circuitry. Example 10 includes the processor of example 1, wherein the processor comprises one or more processor cores, wherein each of the one or more processor cores comprises the SFB predictor and the main branch predictor logic circuitry.

Example 11 includes one or more non-transitory computer-readable media comprising one or more instructions that when executed on a processor configure the processor to perform one or more operations to cause: a Short Forward Branch (SFB) predictor to process one or more short forward branches; and main branch predictor logic circuitry to process one or more long forward branches, wherein the one or more short forward branches jump forward a shorter distance than the long forward branches. Example 12 includes the one or more non-transitory computer-readable media of example 11, further comprising one or more instructions that when executed on the processor configure the processor to perform one or more operations to cause the SFB predictor and the main branch predictor logic circuity to process branches in parallel.

Example 13 includes the one or more non-transitory computer-readable media of example 11, wherein each of the one or more short forward branches includes a branch that jumps forward a short distance on the order of 128 bytes. Example 14 includes the one or more non-transitory computer-readable media of example 11, further comprising one or more instructions that when executed on the processor configure the processor to perform one or more operations to cause a Branch Target Buffer (BTB) of the SFB predictor to store branch decode information.

Example 15 includes the one or more non-transitory computer-readable media of example 11, further comprising one or more instructions that when executed on the processor configure the processor to perform one or more operations a Conditional Branch Predictor (CBP) of the SFB predictor to predict whether a branch should be taken or not taken. Example 16 includes the one or more non-transitory computer-readable media of example 15, further comprising one or more instructions that when executed on the processor configure the processor to perform one or more operations to cause an SFB controller logic of the SFB predictor to synthesis a prediction from outputs of the SFB BTB and SFB CBP. Example 17 includes the one or more non-transitory computer-readable media of example 11, further comprising one or more instructions that when executed on the processor configure the processor to perform one or more operations to cause a hit vector queue to store one or more predictions by the SFB predictor and the main branch predictor logic circuitry.

Example 18 includes a System comprising: a memory to store one or more instructions; a processor to execute the one or more instructions speculatively; and a Short Forward Branch (SFB) predictor to process one or more short forward branches; and a main branch predictor logic circuitry to process one or more long forward branches, wherein the one or more short forward branches jump forward a shorter distance than the long forward branches. Example 19 includes the system of example 18, wherein the SFB predictor and the main branch predictor logic circuity are to process branches in parallel. Example 20 includes the system of example 18, wherein the SFB predictor includes a Branch Target Buffer (BTB) to store branch decode information, a Conditional Branch Predictor (CBP) to predict whether a branch should be taken or not taken, and an SFB controller logic to synthesis a prediction from outputs of the SFB BTB and SFB CBP.

Example 21 includes an apparatus comprising means to perform a method as set forth in any preceding example. Example 22 includes machine-readable storage including machine-readable instructions, when executed, to implement a method or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

In some embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. A processor comprising:
a Short Forward Branch (SFB) predictor to process one or more short forward branches; and
main branch predictor logic circuitry to process one or more long forward branches,
wherein the one or more short forward branches jump forward a shorter distance than the long forward branches.

2. The processor of claim 1, wherein the SFB predictor and the main branch predictor logic circuity are to process branches in parallel.

3. The processor of claim 1, wherein each of the one or more short forward branches includes a branch that jumps forward a short distance on the order of 128 bytes.

4. The processor of claim 1, wherein the SFB predictor includes a Branch Target Buffer (BTB) to store branch decode information.

5. The processor of claim 1, wherein the SFB predictor includes a Conditional Branch Predictor (CBP) to predict whether a branch should be taken or not taken.

6. The processor of claim 1, wherein the SFB predictor includes a Branch Target Buffer (BTB) to store branch decode information, a Conditional Branch Predictor (CBP) to predict whether a branch should be taken or not taken, and an SFB controller logic to synthesis a prediction from outputs of the SFB BTB and SFB CBP.

7. The processor of claim 1, further comprising a hit vector queue to store one or more predictions by the SFB predictor and the main branch predictor logic circuitry.

8. The processor of claim 7, wherein an instruction fetch circuitry is coupled to the hit vector queue to read the one or more stored predictions.

9. The processor of claim 1, wherein a System on Chip (SoC) comprises the SFB predictor and the main branch predictor logic circuitry.

10. The processor of claim 1, wherein the processor comprises one or more processor cores, wherein each of the one or more processor cores comprises the SFB predictor and the main branch predictor logic circuitry.

11. One or more non-transitory computer-readable media comprising one or more instructions that when executed on a processor configure the processor to perform one or more operations to cause:
a Short Forward Branch (SFB) predictor to process one or more short forward branches; and
main branch predictor logic circuitry to process one or more long forward branches,
wherein the one or more short forward branches jump forward a shorter distance than the long forward branches.

12. The one or more non-transitory computer-readable media of claim 11, further comprising one or more instructions that when executed on the processor configure the processor to perform one or more operations to cause the SFB predictor and the main branch predictor logic circuity to process branches in parallel.

13. The one or more non-transitory computer-readable media of claim 11, wherein each of the one or more short forward branches includes a branch that jumps forward a short distance on the order of 128 bytes.

14. The one or more non-transitory computer-readable media of claim 11, further comprising one or more instructions that when executed on the processor configure the processor to perform one or more operations to cause a Branch Target Buffer (BTB) of the SFB predictor to store branch decode information.

15. The one or more non-transitory computer-readable media of claim 11, further comprising one or more instructions that when executed on the processor configure the processor to perform one or more operations a Conditional Branch Predictor (CBP) of the SFB predictor to predict whether a branch should be taken or not taken.

16. The one or more non-transitory computer-readable media of claim 15, further comprising one or more instructions that when executed on the processor configure the processor to perform one or more operations to cause an SFB controller logic of the SFB predictor to synthesis a prediction from outputs of the SFB BTB and SFB CBP.

17. The one or more non-transitory computer-readable media of claim 11, further comprising one or more instructions that when executed on the processor configure the processor to perform one or more operations to cause a hit vector queue to store one or more predictions by the SFB predictor and the main branch predictor logic circuitry.

18. A System comprising:
a memory to store one or more instructions;
a processor to execute the one or more instructions speculatively; and
a Short Forward Branch (SFB) predictor to process one or more short forward branches; and
a main branch predictor logic circuitry to process one or more long forward branches,
wherein the one or more short forward branches jump forward a shorter distance than the long forward branches.

19. The system of claim 18, wherein the SFB predictor and the main branch predictor logic circuity are to process branches in parallel.

20. The system of claim 18, wherein the SFB predictor includes a Branch Target Buffer (BTB) to store branch decode information, a Conditional Branch Predictor (CBP) to predict whether a branch should be taken or not taken, and an SFB controller logic to synthesis a prediction from outputs of the SFB BTB and SFB CBP.
